(19) United States
(12) Patent Application Publication
(10) Pub. No.: US 2004/0267708 A1
(43) Pub. Date: Dec. 30, 2004

(54) Device information collection and error detection in a pre-boot environment of a computer system

(76) Inventors: Michael A. Rothman, Gig Harbor, WA (US); Vincent J. Zimmer, Federal Way, WA (US); J. Martin Wilde, Aloha, OR (US)

Correspondence Address: Anthony H. Azure, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/465,353

(22) Filed: Jun. 18, 2003

(51) Int. Cl. G06F 7/00

(52) U.S. Cl. 707/3

(57) ABSTRACT

A method and system to collect device information and detect errors in devices of a computer system in a pre-boot environment. The firmware of the computer system queries a plurality of devices for health data during the pre-boot phase of the computer system. The firmware provides a pre-boot device manager based on the health data received from the plurality of devices. The pre-boot device manager enables a user to reconfigure the devices during the pre-boot phase. In one embodiment, the firmware of the computer system operates in accordance with the Extensible Firmware Interface (EFI) framework standard to collect device information and detect device errors.

### FIELD OF THE INVENTION

The field of invention relates generally to computer systems and, more specifically but not exclusively, relates to device information collection and error detection during the pre-boot of a computer system.

### BACKGROUND INFORMATION

During a computer system startup, the computer system is self-tested and initialized through loading and execution of system firmware. Under personal computer (PC) architectures, this firmware is commonly referred to as the system's Basic Input/Output System (BIOS). The BIOS also generally provides the basic low-level interface between hardware and software components of those computer systems, enabling specific hardware functions to be implemented via execution of higher-level software instructions contained in computer programs that run on the computer systems.

In a typical PC architecture, the initialization and configuration of the computer system by the BIOS is commonly referred to as the pre-boot phase. It is generally defined as the firmware that runs between the processor reset and the first instruction of the Operating System (OS) loader. At the start of a pre-boot, very little of the system beyond the processor and firmware is actually initialized. It is up to the code in the firmware to initialize the system to the point that an operating system loaded off of media, such as a hard disk, can take over.

Typically, firmware code is stored in a “monolithic” form comprising a single set of code that is provided by a platform manufacturer or a BIOS vendor such as Phoenix Technologies or American Megatrends, Inc. Various portions of the single set of code are used to initialize different system components, while other portions are used for run-time (i.e., post-boot) operations. In other situations, a monolithic BIOS may be extended using one or more “Option ROMs” (Read Only Memory) that are contained on one or more periphery device cards (a.k.a., “add-in” cards). For example, Small Computer System Interface (SCSI) device driver cards and video cards often include an option ROM that contains BIOS code corresponding to services provided by these cards. Typically, firmware in option ROMs is loaded after the firmware in the monolithic BIOS has been loaded or during loading of the monolithic BIOS in accordance with a predefined scheme.

In today's computer systems, computer devices must be configured to operate correctly on the platform on which they are installed. An OS specific set of drivers is often required to enable configuration of a device during OS runtime. Usually, the only tool a user has to identify and fix a configuration problem is a utility that operates during OS runtime, such the Microsoft Windows Device Manager. Typically, the BIOS firmware offers no practical way to diagnose device problems and to assist in analyzing configuration issues.

### BRIEF DESCRIPTION OF THE DRAWINGS

The present invention is illustrated by way of example and not limitation in the accompanying figures.

FIG. 1 a schematic diagram illustrating the various execution phases that are performed in accordance with the Extensible Firmware Interface (EFI) framework standard.

FIG. 2 is a block schematic diagram illustrating various components of the EFI system table that are employed by embodiments of the invention.

FIG. 3 is a flowchart illustrating the logic and operations performed by one embodiment of the invention to collect device information and to detect device errors in a computer system.

FIG. 4 is a user interface diagram according to one embodiment of the present invention.

FIG. 5 is a user interface diagram according to one embodiment of the present invention.

FIG. 6 is a user interface diagram according to one embodiment of the present invention.

FIG. 7 is a schematic diagram illustrating a computer system that may be used to practice an embodiment of the present invention.

### DETAILED DESCRIPTION

Embodiments of a method to collect device information and to detect device errors and computer apparatus for implementing the method are described herein. In the following description, numerous specific details are set forth, such as embodiments pertaining to the Extensible Firmware Interface (EFI) framework standard, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In accordance with aspects of the invention, a mechanism is disclosed to collect device information and to detect device errors of a computer system. Firmware components, using a pull model, actively query and investigate devices to collect health data. The information is gathered in a central repository and is accessible to a user via a pre-boot device manager. The pre-boot device manager facilitates troubleshooting and re-configuration of the devices by the user during the pre-boot phase. Diagnosing device problems during pre-boot offers the opportunity to fix errors that one may not be able to resolve during OS runtime. Also, making repairs in pre-boot prevents faulty device configurations that may cause a computer crash during OS boot or OS runtime.

In accordance with one embodiment, device information collection and error detection may be implemented under an extensible firmware framework known as the Extensible Firmware Interface (EFI) (specifications and examples of which may be found at http://developer.intel.com/technology/efi). EFI is a public industry specification that describes an abstract programmatic interface between platform firmware and shrink-wrap operating systems or other custom application environments. The EFI framework standard include provisions for extending BIOS functionality beyond that provided by the BIOS code stored in a platform's BIOS device (e.g., flash memory). More particularly, EFI enables firmware, in the form of firmware modules and drivers, to be loaded from a variety of different resources, including primary and secondary flash devices, option ROMs, various persistent storage devices (e.g., hard disks, CD ROMs, etc.), and even over computer networks.

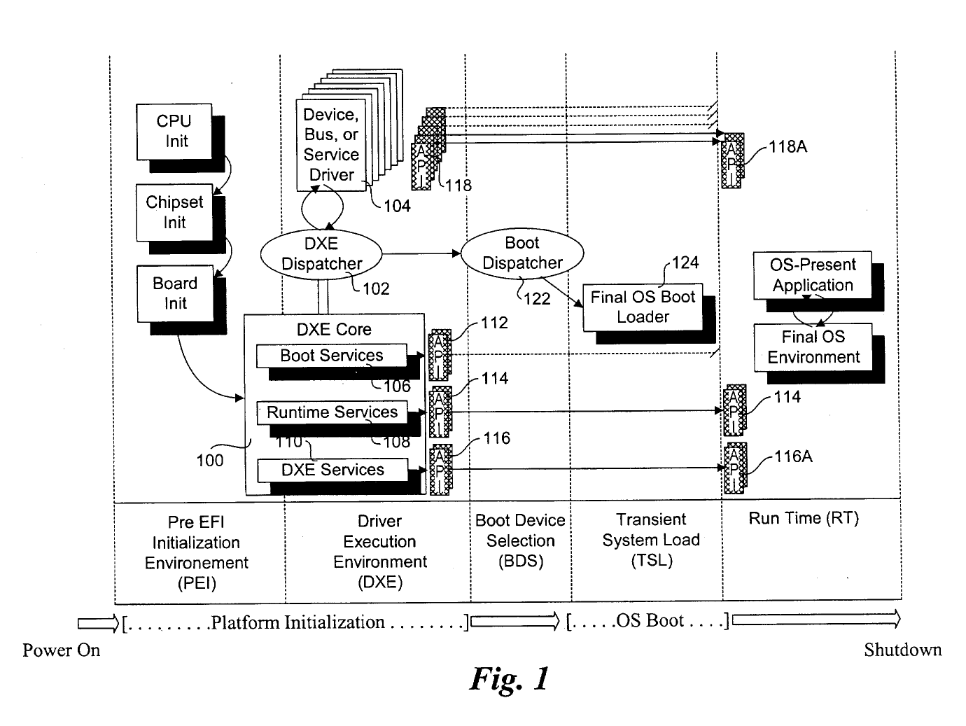

FIG. 1 shows an event sequence/architecture diagram used to illustrate operations performed by a platform under one implementation of the EFI framework standard. The process is logically divided into several phases, including a pre-EFI Initialization Environment (PEI) phase, a Driver Execution Environment (DXE) phase, a Boot Device Selection (BDS) phase, a Transient System Load (TSL) phase, and an operating system run-time (RT) phase. The phases build upon one another to provide an appropriate run-time environment for the OS and platform.

The PEI phase provides a standardized method of loading and invoking specific initial configuration routines for the central processing unit (CPU), chipset, and motherboard. The PEI phase is responsible for initializing enough of the system to provide a stable base for the follow on phases. Initialization of the platforms core components, including the CPU, chipset and main board (i.e., motherboard) is performed during the PEI phase. This phase is also referred to as the “early initialization” phase. Typical operations performed during this phase include the POST (power-on self test) operations and discovery of platform resources. In particular, the PEI phase discovers memory and prepares a resource map that is handed off to the DXE phase. The state of the system at the end of the PEI phase is passed to the DXE phase through a list of position independent data structures called Hand Off Blocks (HOBs).

The DXE phase is the phase during which most of the system initialization is performed. The DXE phase is facilitated by several components, including the DXE Core 100, the DXE Dispatcher 102, and a set of DXE drivers 104. The DXE Core 100 produces a set of Boot Services 106, Runtime Services 108, and DXE Services 110. The DXE Dispatcher 102 is responsible for discovering and executing DXE drivers 104 in the correct order. The DXE drivers 104 are responsible for initializing the processor, chipset, and platform components as well as providing software abstractions for console and boot devices. These components work together to initialize the platform and provide the services required to boot an operating system. The DXE and the Boot Device Selection phases work together to establish consoles and attempt the booting of operating systems. The DXE phase is terminated when an operating system successfully begins its boot process (i.e., the BDS phase starts). Only the runtime services and selected DXE services provided by the DXE Core and selected services provided by runtime DXE drivers are allowed to persist into the OS runtime environment. The result of DXE is the presentation of a fully formed EFI interface.

The DXE Core is designed to be completely portable with no CPU, chipset, or platform dependencies. This is accomplished by designing in several features. First, the DXE Core only depends upon the HOB list for its initial state. This means that the DXE Core does not depend on any services from a previous phase, so all the prior phases can be unloaded once the HOB list is passed to the DXE Core. Second, the DXE Core does not contain any hard coded addresses. This means that the DXE Core can be loaded anywhere in physical memory, and it can function correctly no matter where physical memory or where firmware segments are located in the processor's physical address space. Third, the DXE Core does not contain any CPU-specific, chipset specific, or platform specific information. Instead, the DXE Core is abstracted from the system hardware through a set of architectural protocol interfaces. These architectural protocol interfaces are produced by DXE drivers 104, which are invoked by DXE Dispatcher 102.

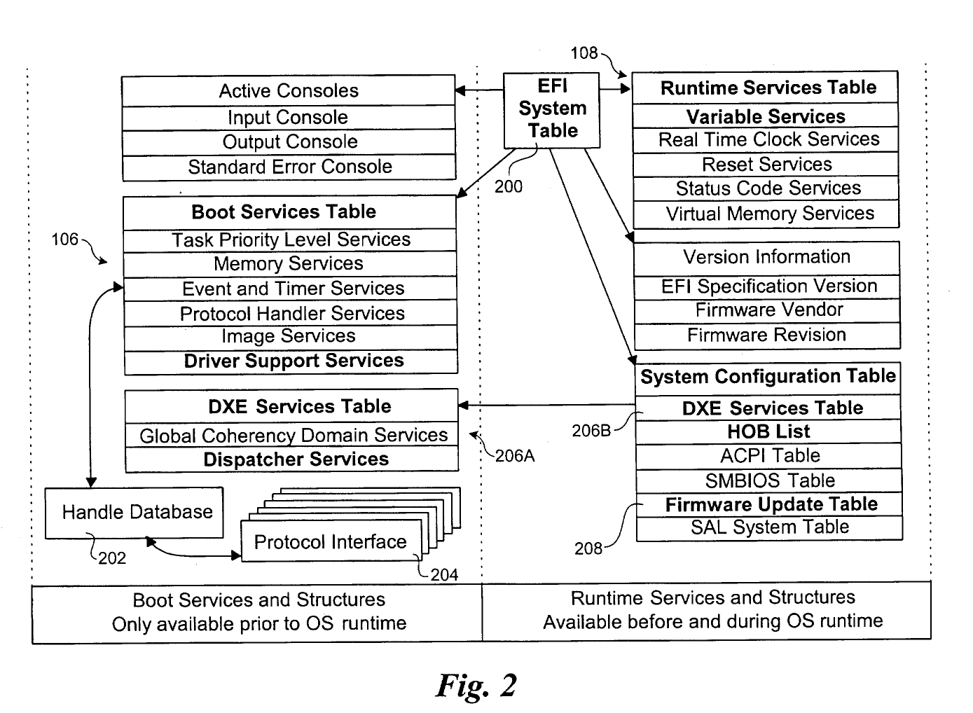

The DXE Core produces an EFI System Table 200 and its associated set of Boot Services 106 and Runtime Services 108, as shown in FIG. 2. The DXE Core also maintains a handle database 202. The handle database comprises a list of one or more handles, wherein a handle is a list of one or more unique protocol GUID's (Globally Unique Identifiers) that map to respective protocols 204. A protocol is a software abstraction for a set of services. Some protocols abstract I/O devices, while other protocols abstract a common set of system services. A protocol typically contains a set of API's (Application Program Interface) and some number of data fields. Every protocol is named by a GUID, and the DXE Core produces services that allow protocols to be registered in the handle database. As the DXE Dispatcher executes DXE drivers, additional protocols will be added to the handle database including the architectural protocols used to abstract the DXE Core from platform specific details.

The Boot Services comprise a set of services that are used during the DXE and BDS phases. Among others, these services include Memory Services, Protocol Handler Services, and Driver Support Services: Memory Services provide services to allocate and free memory pages and allocate and free the memory pool on byte boundaries. It also provides a service to retrieve a map of all the current physical memory usage in the platform. Protocol Handler Services provides services to add and remove handles from the handle database. It also provides services to add and remove protocols from the handles in the handle database. Addition services are available that allow any component to lookup handles in the handle database, and open and close protocols in the handle database. Support Services provides services to connect and disconnect drivers to devices in the platform. These services are used by the BDS phase to either connect all drivers to all devices, or to connect only the minimum number of drivers to devices required to establish the consoles and boot an operating system (i.e., for supporting a fast boot mechanism).

In contrast to Boot Services, Runtime Services are available both during pre-boot and OS runtime operations. One of the Runtime Services that is leveraged by embodiments disclosed herein is the Variable Services. As described in further detail below, the Variable Services provide services to lookup, add, and remove environmental variables from both volatile and non-volatile storage. As used herein, the Variable Services is termed “generic” since it is independent of any system component for which firmware is updated by embodiments of the invention.

The DXE Services Table includes data corresponding to a first set of DXE services 206A that are available during pre-boot only, and a second set of DXE services 206B that are available during both pre-boot and OS runtime. The pre-boot only services include Global Coherency Domain Services, which provide services to manage I/O resources, memory mapped I/O resources, and system memory resources in the platform. Also included are DXE Dispatcher Services, which provide services to manage DXE drivers that are being dispatched by the DXE Dispatcher.

The services offered by each of Boot Services 106, Runtime Services 108, and DXE services 110 are accessed via respective sets of API's 112, 114, and 116. The API's provide an abstracted interface that enables subsequently loaded components to leverage selected services provided by the DXE Core.

After DXE Core 100 is initialized, control is handed to the DXE Dispatcher 102. The DXE Dispatcher is responsible for loading and invoking DXE drivers found in firmware volumes, which correspond to the logical storage units from which firmware is loaded under the EFI framework standard. The DXE Dispatcher searches for drivers in the firmware volumes described by the HOB List. As execution continues, other firmware volumes might be located. When they are located, the DXE Dispatcher searches them for drivers as well.

There are two subclasses of DXE drivers. The first subclass includes DXE drivers that execute very early in the DXE phase. The execution order of these DXE drivers depends on the presence and contents of an a priori file and the evaluation of dependency expressions. These early DXE drivers will typically contain processor, chipset, and platform initialization code. These early drivers will also typically produce the architectural protocols that are required for the DXE Core to produce its full complement of Boot Services and Runtime Services.

The second subclass of DXE drivers are those that comply with the EFI 1.10 Driver Model. These drivers do not perform any hardware initialization when they are executed by the DXE Dispatcher. Instead, they register a Driver Binding Protocol interface in the handle database. The set of Driver Binding Protocols are used by the BDS phase to connect the drivers to the devices required to establish consoles and provide access to boot devices. The DXE Drivers that comply with the EFI 1.10 Driver Model ultimately provide software abstractions for console devices and boot devices when they are explicitly asked to do so.

Any DXE driver may consume the Boot Services and Runtime Services to perform their functions. However, the early DXE drivers need to be aware that not all of these services may be available when they execute because all of the architectural protocols might not have been registered yet. DXE drivers must use dependency expressions to guarantee that the services and protocol interfaces they require are available before they are executed.

The DXE drivers that comply with the EFI 1.10 Driver Model do not need to be concerned with this possibility. These drivers simply register the Driver Binding Protocol in the handle database when they are executed. This operation can be performed without the use of any architectural protocols. In connection with registration of the Driver Binding Protocols, a DXE driver may “publish” an API by using the InstallProtocolInterface function. These published drivers are depicted by API's 118. Under EFI, publication of an API exposes the API for access by other firmware components. The API's provide interfaces for the Device, Bus, or Service to which the DXE driver corresponds during their respective lifetimes.

The BDS architectural protocol executes during the BDS phase. The BDS architectural protocol locates and loads various applications that execute in the pre-boot services environment. Such applications might represent a traditional OS boot loader, or extended services that might run instead of, or prior to loading the final OS. Such extended pre-boot services might include setup configuration, extended diagnostics, flash update support, OEM value-adds, or the OS boot code. A Boot Dispatcher 122 is used during the BDS phase to enable selection of a Boot target, e.g., an OS to be booted by the system.

During the TSL phase, a final OS Boot loader 124 is run to load the selected OS. Once the OS has been loaded, there is no further need for the Boot Services 106, and for many of the services provided in connection with DXE drivers 104 via API's 118, as well as DXE Services 206A. Accordingly, these reduced sets of API's that may be accessed during OS runtime are depicted as API's 116A, and 118A in FIG. 1. API's 114 provide for Runtime Services so are also shown in FIG. 1 to be available during OS runtime.

In accordance with aspects of the invention, the pre-boot/boot framework of FIGS. 1 and 2 may be implemented to investigate the health condition of computer devices and to enable reconfiguration of the devices. This is facilitated, in part, by API's published by respective components/devices during the DXE phase, and through use of the Variable Services runtime service.

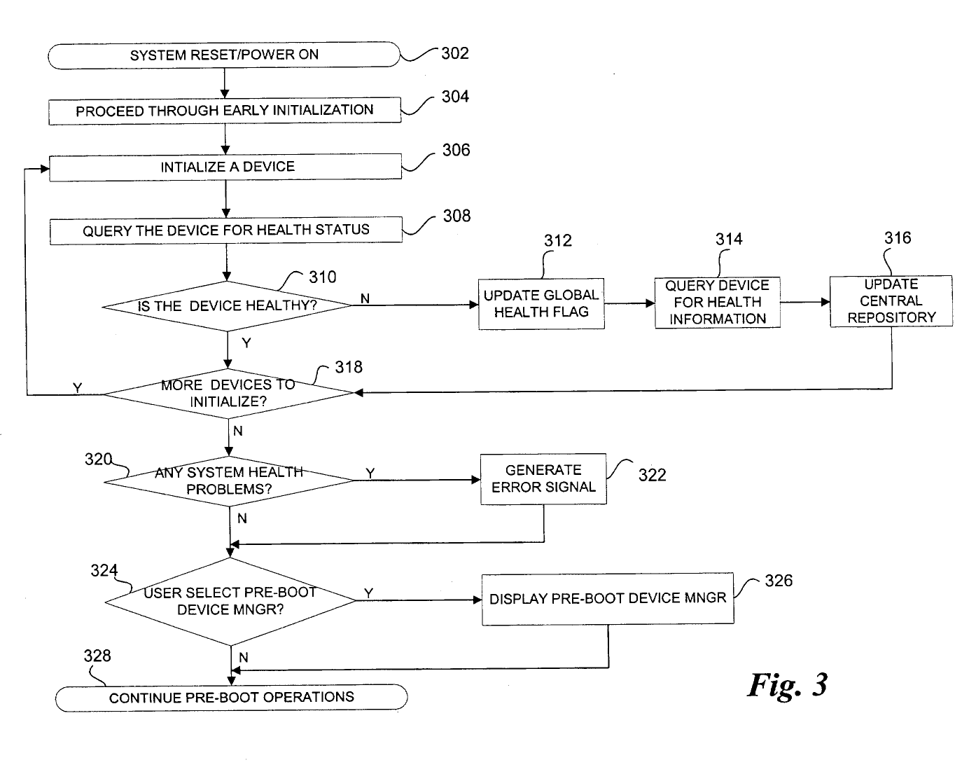

A flowchart illustrating further details of logic and operations performed in accordance with one embodiment of the present invention is shown in FIG. 3. The embodiment of FIG. 3 shows a method to collect information and to detect errors in devices of a computer system during the pre-boot phase. The process begins in a block 302, which corresponds to a system startup event, i.e., a cold boot or a system reset.

In response to the startup event, pre-boot initialization of the computer system will begin through loading and execution of system boot instructions stored in the computer system BIOS firmware, as depicted by a block 304. In one embodiment, the system boot instructions will begin initializing the platform by conducting a Power-On Self-Test (POST) routine, initializing system board functions, checking for any expansion boards that hold additional BIOS code, and loading such BIOS code if any is found.

In a block 306, a device of the computer system is initialized. As described below, the BIOS firmware initializes each device and gathers health data in a sequential order until all devices have been initialized (shown in FIG. 3 as a loop between blocks 306 and 318). Examples of health data include a Boolean health status of healthy/unhealthy and health information. Such health information includes, but is not limited to, a device's port settings, Direct Memory Access (DMA) channel, memory address, driver version number, storage capacity (if applicable), security settings, or the like. Health information may also include information regarding interrupt conflicts, incompatible device settings, unresponsive device components, device memory conflicts, or the like.

In an embodiment under the EFI framework standard described above, the DXE Core is working through the DXE Dispatcher to initialize devices in a pre-determined order. During initialization, the device will export its setup data and configuration information to a central repository. The central repository is constructed by a Boot Services driver and maintained by the DXE Core. The central repository usually resides in memory discovered during pre-boot. The central repository continues to reside in OS runtime memory and data from the central repository is advertised in the System Configuration Table.

The logic proceeds to a block 308 to query the device regarding the device's health status. This scheme operates on a pull model where the firmware questions the devices of the computer system to verify their health status. In one embodiment, the health status request returns a Boolean response of healthy or unhealthy. In a decision block 310, the logic receives a response from the device regarding its health status. In one embodiment, if the device fails to respond to the health status query, then the logic assumes a device error and regards the devices health status as unhealthy. If the answer to decision block 310 is yes, then the logic proceeds to a decision block 318 to determine if there are any more devices to be initialized.

If the answer to decision block 310 is no, then the logic proceeds to a block 312. In block 312, a global health flag is updated. In one embodiment, the global health flag is a Boolean indicator of the health of the computer system. The global health flag indicates to the firmware that at least one device in the system is reporting an unhealthy status. At startup, the global health flag is set to a default of healthy. As the firmware initializes each device and queries its health, the global health flag will be set to a state of unhealthy if any single device reports a problem (or does not respond at all). In an embodiment in an EFI-compliant system, the global health flag is advertised as part of the System Configuration Table. The global health flag includes a GUID pointer that the system can look up in the System Configuration Table to realize the state of the global health flag. The GUID pointer contains the address of a buffer in which the global health flag is stored.

After updating the global health flag, the logic proceeds to a block 314, to query the device for health information. The firmware actively investigates an unhealthy device to gather more information regarding the device's health condition. The pull model of the firmware overcomes the limitations of devices that cannot independently communicate information about settings that have caused a failure. In one embodiment, the firmware queries all devices for detailed health information without waiting for a negative health status report. The information is used to indicate setting optimizations even when the current device settings are not causing a failure.

In one embodiment, the firmware calls a Health API. The Health API is published for each device after it is initialized by the DXE Dispatcher and the device's DXE driver is executed. Thus, each device has a corresponding DXE driver and a corresponding Health API. The DXE driver will export health data to the Health API when requested by the Health API. The Health API enables any component to call the Health API and query a device (via the device's DXE driver) about the device's health. In one embodiment, the questions asked by the Health API are maintained as variable data for each device.

In one embodiment, the Health API returns a Boolean state of healthy/unhealthy. In another embodiment, the Health API would return detailed health information regarding the health condition of the device. The Health API asks the device a predetermined list of questions regarding its state. In one embodiment, the Health API returns a set of question numbers that had negative or unknown results. For example, the Health API would query 20 health questions to a device and would return questions number 3 and number 18 as having unhealthy results. In another embodiment, the Health API returns device data corresponding to each of the questions asked.

In one embodiment of the present invention, the results of the Health API call to a device is maintained between boots in a non-volatile storage device. Such non-volatile storage includes the NVRAM (Nonvolatile Random Access Memory) Data of an EFI-compliant system. In this way, a user could track device configuration and health status across several pre-boot phases. In another embodiment, data from the Health API is placed in the EFI System Configuration Table. The data then becomes available to the operating system during OS runtime.

Referring again to FIG. 3, in a block 316, the results of the health query in block 314 are used to update the central repository. After the central repository is updated, the logic proceeds to decision block 318 to determine if there are any more devices to be initialized. If the answer is yes, the logic returns to block 306 to initialized the next device. If the answer is no, then the logic proceeds to a decision block 320.

In decision block 320, the global health flag is analyzed to determine if any devices are reporting health problems. If the global health flag indicates an unhealthy state, then an error signal is generated, as depicted in a block 322. In one embodiment, the error signal is used to generate an error message for the user of the computer system. After the error signal is generated, the logic continues to a decision block 324. If the global health flag indicates no health problems in decision block 320, then the logic proceeds directly to decision block 324.

In decision block 324, the logic determines if the user has selected to view a pre-boot device manager. If the answer to decision block 324 is no, then the logic proceeds to block 328 to continue the pre-boot phase. If the answer to block 324 is yes, then the logic proceeds to block 326 to display the pre-boot device manager.

The pre-boot device manager provides a user interface to enable a user to examine and reconfigure the devices of the computer system. The pre-boot device manager displays information from the central repository to show the status of the devices and indicate which devices indicate an unhealthy state. In one embodiment, the pre-boot device manager displays device information obtained from the Health API to provide detailed device state information. In another embodiment, the device manager displays alternative configurations to cure the unhealthy device.

In another embodiment, the device manager displays alternative device settings to optimize device configurations. The firmware calls a Health API for each device and uses the information gathered to show alternative configurations to optimize device configurations. For example, an Integrated Drive Electronics (IDE) disk drive is configured to be accessed in Programmed Input/Output (PIO) mode, but the DXE driver, which has a more intimate knowledge of the device, reports via the Health API that the configuration would be enhanced in an Ultra Direct Memory Access (UDMA) mode. The device manager would display an alert indicating an optimized setting is available for the IDE disk drive.

In one embodiment, the pre-boot device manager offers the user the opportunity to reboot the computer system. This would allow the user to determine if configuration changes made via the pre-boot device manager fixed any reported health problems. After the user has finished with the pre-boot device manager, the logic proceeds to a block 328 to continue the pre-boot phase.

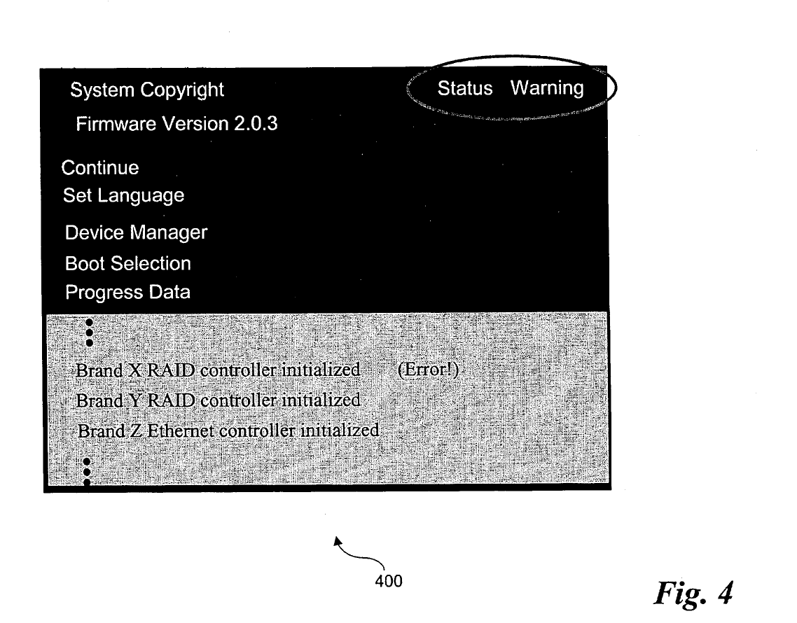

FIGS. 4-6 illustrate user interfaces according to one embodiment of the present invention. FIG. 4 shows a pre-boot main page menu 400 provided by the firmware of a computer system. The menu 400 includes several user options including a “Device Manager.” The menu 400 also shows a warning message in the upper right hand corner. This warning message indicates that at least one device of the computer system has a health problem. For example, referring to FIG. 3, if an error signal was generated in block 322 due to a system health problem, then the error signal would be used to create the warning message of menu 400. The bottom of menu 400 shows that a Brand X RAID Controller has been discovered by the firmware to have a health problem.

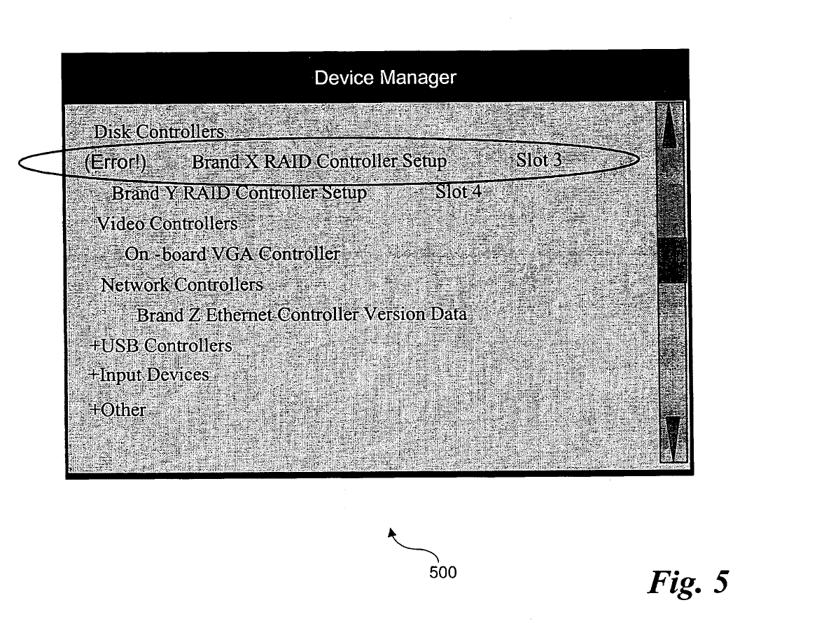

After a user selects the Device Manager option of menu 400, then the “Device Manager” menu 500 is displayed, as shown in FIG. 5. The Device Manager menu 500 shows several devices of the computer system including Disk Controllers, Video Controllers, Network Controllers, Universal Serial Bus (USB) Controllers, and Input Devices. The menu 500 also shows an error message in association with the Brand X RAID Controller Setup of the Disk Controllers.

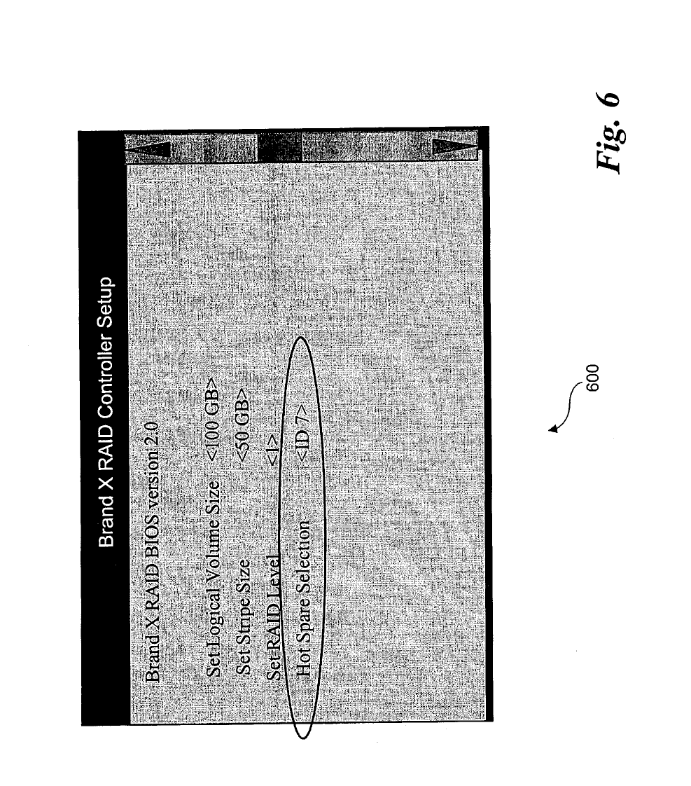

FIG. 6 shows a Brand X RAID Controller Setup menu 600 generated in response to a user selecting the Brand X RAID Controller Setup option from the Device Manager menu 500. The menu 600 displays detailed information regarding the Brand X RAID Controller including the Logical Volume Size, the Stripe Size, the RAID level, and the Hot Spare Selection. In one embodiment, the RAID Controller was queried for detailed health information after reporting a health status of unhealthy. This detailed health information was stored in a central repository and available to the device manager to display to the user in menu 600. The Hot Spare Selection is highlighted as the source of the health problem. The user can use the menu 600 to reconfigure the Brand X RAID Controller to eliminate the health problem.

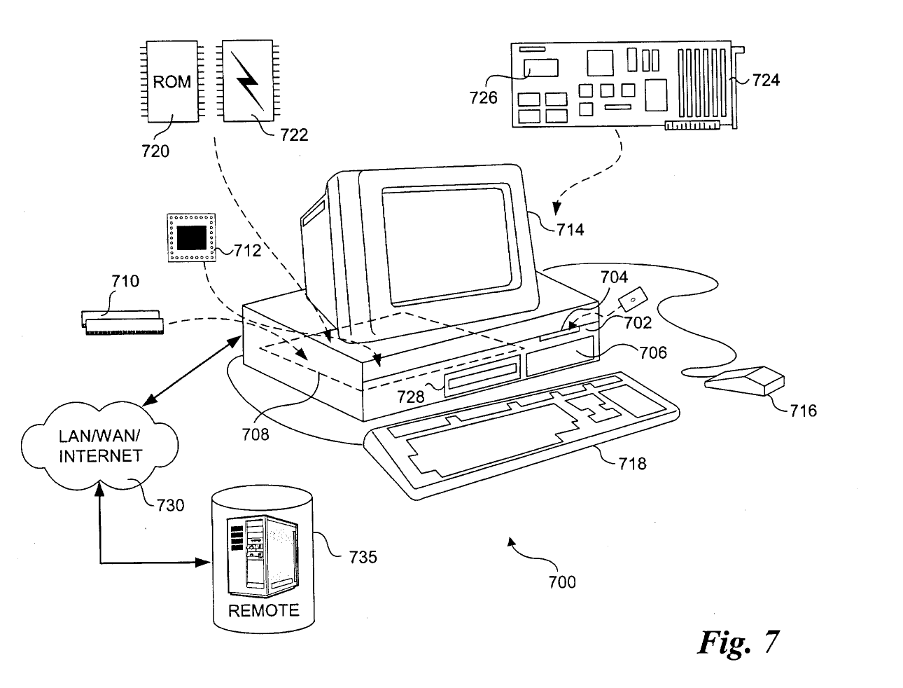

FIG. 7 illustrates an embodiment of an exemplary computer system 700 to practice embodiments of the invention described above. Computer system 700 is generally illustrative of various types of computer devices, including personal computers, laptop computers, workstations, servers, etc; for simplicity, only the basic components of the computer system are discussed herein. Computer system 700 includes a processor chassis 702 in which various hardware components are housed, including a floppy disk drive 704, a hard disk 706, a power supply (not shown), and a motherboard 708 populated with appropriate integrated circuits including system memory 710 coupled to one or more processors 712. System memory 710 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. Processor 712 may be a conventional microprocessor including, but not limited to, an Intel Corporation x86, Pentium, or Itanium family microprocessor, a Motorola family microprocessor, or the like. Hard disk 706 may comprise a single unit, or multiple units, and may optionally reside outside of computer system 700. The system also includes a boot firmware device on which firmware is stored, which may typically comprise non-volatile memory such as a ROM device 720 or a flash device 722. Other non-volatile memory devices include, but are not limited to, an Erasable Programmable Read Only Memory (EPROM), an Electronically Erasable Programmable Read Only Memory (EEPROM), or the like. The motherboard may include other firmware devices as well (not shown). In general, the system's processors will comprise 32- or 64-bit architectures, and the system memory will include physical addressing schemes appropriate to the processor(s), and may be accessed via corresponding address and data buses to which the processor(s) and the memory are connected.

A monitor 714 is included for displaying graphics and text generated by firmware, software programs and program modules that are run by computer system 700, such as system information presented during system boot. A mouse 716 (or other pointing device) may be connected to a serial port, USB port, or other like bus port communicatively coupled to processor(s) 712. A keyboard 718 is communicatively coupled to motherboard 708 in a similar manner as mouse 716 for user entry of text and commands. In one embodiment, computer system 700 also includes a network interface card NIC or built-in NIC interface (not shown) for connecting computer system 700 to a computer network 730, such as a local area network (LAN), wide area network (WAN), or the Internet. In one embodiment network 730 is further coupled to a remote computer 735, such that computer system 700 and remote computer 735 can communicate. In one embodiment, a portion of the system's firmware is loaded during system boot from remote computer 735.

The illustrated embodiment further includes an optional add-in card 724 that is coupled to an expansion slot of motherboard 708. In one embodiment, add-in card 724 includes an Option ROM 726 on which firmware is stored. Computer system 700 may also optionally include a compact disk-read only memory (“CD-ROM”) drive 728 into which a CD-ROM disk may be inserted so that executable files, such as an operating system, and data on the disk can be read or transferred into system RAM 710 and/or hard disk 706. Other mass memory storage devices may be included in computer system 700.

In another embodiment, computer system 700 is a handheld or palmtop computer, which are sometimes referred to as personal digital assistants (PDAs). Handheld computers may not include a hard disk or other mass storage, and the executable programs are loaded from a corded or wireless network connection into memory 710 for execution by processor 712. A typical computer system 700 will usually include at least a processor 712, memory 710, and a bus (not shown) coupling the memory 710 to the processor 712.

It will be appreciated that in one embodiment, computer system 700 is controlled by operating system software that includes a file management system, such as a disk operating system, which is part of the operating system software. For example, one embodiment of the present invention utilizes Microsoft Windows as the operating system for computer system 700. In another embodiment, other operating systems such as, for example, but not limited to the Apple Macintosh operating system, the Linux operating system, the Microsoft Windows CE operating system, the Unix operating system, the 3Com Palm operating system, or the like may also be use in accordance with the teachings of the present invention.

Thus, embodiments of this invention may be used as or to support a firmware and software code executed upon some form of processing core (such as processor 712) or otherwise implemented or realized upon or within a machine-readable medium. A machine-readable medium includes any mechanism that provides (i.e., stores and/or transmits) information in a form readable by a machine (e.g., a computer, network device, personal digital assistant, manufacturing tool, any device with a set of one or more processors, etc.). For example, a machine-readable medium can includes, but is not limited to, a read only memory (ROM), a random access memory (RAM), a magnetic disk storage media, an optical storage media, a flash memory device, or the like. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
querying a plurality of devices of a computer system for health data during a pre-boot phase of the computer system; and
providing a pre-boot device manager that includes at least a portion of the health data to enable a user to reconfigure the plurality of devices during the pre-boot phase.

2. The method of claim 1, wherein querying the device for health data comprises:
requesting a health status from each of the plurality of devices; and
updating a global health indicia of the computer system based on the health statuses received from each of the plurality of devices, the global health indicia to indicate an overall health condition of the computer system.

3. The method of claim 2, further comprising querying a given device from among the plurality of devices for health information if the health status received from the given device indicates the device is unhealthy.

4. The method of claim 3, wherein querying the given device for health information comprises executing a health programmatic interface by firmware to facilitate querying the device.

5. The method of claim 1, further comprising maintaining health data corresponding to a current pre-boot phase in a non-volatile manner to be available to firmware upon a subsequent boot of the computer system.

6. The method of claim 1, further comprising initializing each of the plurality of devices during the pre-boot phase of the computer system and storing configuration information for each of the plurality of devices in a central repository.

7. The method of claim 6, further comprising recording the health data received from each of the plurality of devices in the central repository.

8. The method of claim 6, wherein the pre-boot device manager includes information from the central repository.

9. The method of claim 1, further comprising generating an error signal if the health data indicates at least one of the plurality of devices is unhealthy.

10. The method of claim 1, wherein the pre-boot device manager indicates an alternative configuration for at least one of the plurality of devices.

11. The method of claim 1, wherein the method is performed by firmware executed by the computer system in accordance with an Extensible Firmware Interface (EFI) framework standard.

12. An article of manufacture comprising:
a machine-readable medium on which a plurality of instructions are stored, which when executed perform operations comprising:
storing configuration information of a plurality of devices of a computer system received from each device during a pre-boot phase of the computer system;
querying each of the plurality of devices for a health status during pre-boot phase; and
in response to receiving a health status of unhealthy from an unhealthy device,
querying the unhealthy device for health information during the pre-boot phase;
receiving health information from the unhealthy device in response to the query; and
recording the health information.

13. The article of manufacture of claim 12, wherein execution of the instructions further performs the operations of providing a pre-boot device manager that includes configuration information and health information corresponding to the plurality of devices, the pre-boot device manager to enable a user to reconfigure the plurality of devices during the pre-boot phase.

14. The article of manufacture of claim 13, wherein the pre-boot device manager indicates what device settings caused the unhealthy device to report the health status of unhealthy.

15. The article of manufacture of claim 13, wherein the device manager indicates the availability of an alternative configuration of the unhealthy device.

16. The article of manufacture of claim 13, wherein the device manager indicates the availability of an alternative configuration to optimize the configuration of at least one of the plurality of devices.

17. The article of manufacture of claim 12, further comprising updating global health indicia of the computer system based on the health statuses received from the plurality of devices, the global health indicia to indicate if at least one device of the plurality of devices is unhealthy.

18. The article of manufacture of claim 12, wherein execution of the instructions further performs the operation of generating an error signal if the health status reported by at least one of the plurality of devices is unhealthy.

19. The article of manufacture of claim 12, wherein querying the device for health information comprises implementing a health programmatic interface via firmware to facilitate querying the device.

20. The article of manufacturer of claim 19, wherein the health programmatic interface is configured to perform the query based on questions maintained in a non-volatile storage device.

21. The article of manufacture of claim 12, wherein the health information of the device in a current pre-boot phase is maintained in a non-volatile manner to be available to firmware upon a subsequent boot of the computer system.

22. The article of manufacture of claim 12, wherein the plurality of instructions to operate in accordance with an Extensible Firmware Interface (EFI) framework standard.

23. A computer system, comprising:
a processor;
a monitor, operatively coupled to the processor; and
at least one flash device operatively coupled to the processor on which firmware instructions are stored, which when executed by the processor perform operations comprising:
querying a plurality of devices of the computer system for health data during a pre-boot phase of the computer system;
recording the health data received from the plurality of devices in a central repository; and
providing a user interface comprising a pre-boot device manager via the monitor to display information from the central repository to a user of the computer system.

24. The computer system of claim 23, wherein querying the plurality of devices comprises:
requesting a health status from each of the plurality of devices; and
updating global health indicia of the computer system based on the health statuses received from each of the plurality of devices, the global health indicia to indicate an overall health condition of the computer system.

25. The computer system of claim 24, wherein execution of the firmware instructions further performs the operations of querying a device of the plurality of devices for health information if the health status received from the device indicates the device is unhealthy.

26. The computer system of claim 25, wherein querying the device for health information comprises implementing a health programmatic interface to facilitate querying the device.

27. The computer system of claim 23, wherein execution of the firmware instructions further performs the operation of reconfiguring a selected device from among the plurality of devices in response to a user request received via the pre-boot device manager.

28. The computer system of claim 23 wherein execution of the firmware instructions further performs the operation of generating an error signal if the health data indicates that at least one of the plurality of devices is unhealthy.

29. The computer system of claim 23, wherein the firmware instructions to operate in accordance with an Extensible Firmware Interface (EFI) framework standard.
